(19) United States
(12) Patent Application Publication
(10) Pub. No.: US 2010/0127136 A1
(43) Pub. Date: May 27, 2010

(54) LUG-MOUNT SYSTEM FOR FREE STANDING DISPLAY STAND ARM

(76) Inventor: Brad Markoff, Los Angeles, CA (US)

Correspondence Address: BRUCE A. JAGGER;Brooks Kushman P.C., 1000 Town Center, 22nd Floor, Southfield, MI, 48075, US

(21) Appl. No.: 12/691,628

(22) Filed: Jan. 21, 2010

Related U.S. Application Data
(63) Continuation-in-part of application No. 12/352,921, filed on Jan. 13, 2009, now abandoned.
(60) Provisional application No. 61/022,489, filed on Jan. 21, 2008.

(51) Int. Cl. F16M 11/04

(52) U.S. Cl. 248/121

(57) ABSTRACT

A lug mount system in which a generally U-shaped lug engaging member is secured to a display panel member so that information presented by the display panel member is easily viewed. The system is mounted to the proximal end of an arm of a conventional free standing display stand by engagement with a lug on the proximal end of the arm. The lug engaging member and the display panel member may be releasably or permanently secured to one another. The display panel member may include provisions for lighting, animation, electronic displays, and print media. When the display panel member and the lug engaging member are releasably secured together the connection therebetween may be configured so that compound motion is required to release them.

### RELATED APPLICATIONS

This application is a continuation-in-part of U.S. Ser. No. 12/352,921, filed Jan. 13, 2009, and claims the benefit of U.S. Provisional patent application Ser. No. 61/022,489, filed Jan. 21, 2008.

### TECHNICAL FIELD OF THE INVENTION

The present invention relates generally to lug-mount systems for mounting on the ends of conventional free standing display stand arms to provide for displaying graphical or textual information.

### BACKGROUND OF THE INVENTION

Free standing display stands are employed in a wide variety of retail, commercial, and other operations to display goods, tools, and equipment of many different kinds, including, for example, hardware, tools, articles of clothing, floor covering samples, and the like. Such display stands are free standing to readily permit their movement from one location to another in an open space. Typically, such free standing display stands have generally horizontally or angularly downwardly extending arms. Such arms are mounted at their distal ends to a normally generally vertically extending pole or rail, which in turn is supported by feet that are adapted to moveably rest on a floor or other generally horizontal surface. The proximal ends of such arms include a lug that extends upwardly therefrom. The lugs may be located at the extreme proximal location on the arm, or they may be spaced slightly from that location. The lugs may be of any shape so long as they serve to prevent hangers from sliding off the proximal end of the arm. Typical lug shapes include, for example, flat tabs projecting upwardly from the arm and oriented either along or laterally of the major axis of the arm, or cylinders projecting upwardly from the arm. The conventional purpose of these lugs is to prevent hangers, packages, hooks, and other article support members from sliding off the proximal end of the arm.

It would be of great benefit if information could be displayed in immediate association with each individual arm, particularly if such information could be changed at will by a responsible person where the free standing display stand is located. Those skilled in the free standing display stand art recognize that improvements are needed in this area.

### SUMMARY OF THE INVENTION

Embodiments of a lug-mount system allow for presenting information on a proximal end of an arm in a conventional free standing display stand. The arm includes a lug element located at approximately the proximal end of the arm. The lug element projects generally upwardly from the arm. In conventional use the lug element is provided to prevent hangers from sliding off the proximal end of the arm.

Embodiments of the present lug-mount system comprise a lug engaging member that has a generally U-shaped configuration. The U-shaped configuration includes a base portion extending generally opposed first and second leg portions. The two leg portions and the base portion define therebetween three sides of an engagement cavity. A fourth side, generally opposed to the base portion is generally open to receive the proximal end of the arm. The obverse face of the generally U-shaped lug engaging member is also generally open to receive the proximal end of the arm. A lug engaging opening generally extends through the base portion and is adapted to releasably interengage with the generally upwardly projecting lug element. The engagement cavity is thus adapted to engagingly receive the proximal end of the arm.

In use, the engagement cavity is inserted generally over the proximal end of the arm and into engagement with the lug element. In some embodiments the base portion is positioned at what in use is the normally upper end of the engagement cavity. The base portion thus serves, among other things, to prevent the end of the arm from moving upwardly out of the engagement cavity.

Embodiments of the lug mount system include a display panel member that is adapted to present information in an easily visible manner to those who view it. Such information may include, for example, advertising and promotional materials or instructional or informational text or graphics on safety, identification, or use, relating to the sale goods, tools, equipment, or other items hanging on the arm. Where, for example, the things hanging on the arm are for sale, the information may include, price, size, examples of related goods, examples of use, or the like. Where, for example, the things hanging on the arm are work or safety related, the free standing display stand may be positioned in a convenient location and information about the nature or use of the things on the arm is presented by the display panel member.

The information presented by a display panel member may be static, as in printed material, or animated as in digital or analog images that constantly change on, for example, an LCD or other conventional image displaying screen or panel. When desired, the display panel member may be made self illuminating by the incorporation of light emitting diodes, incandescent, fluorescent, or other conventional light emitting devices. Where such light emitting or image displaying devices are part of the display panel member, suitable power supplies for operating such devices may be provided in association with the display panel member.

According to certain embodiments, the display panel member includes a pocket that is adapted to open and retainingly receive a sheet of material bearing the desired information. Embodiments of the display panel member that are oriented generally perpendicular to the major axis of the arm afford a viewer easy visual access to the information presented there. The display panel member may be planar, or arcuate, or a combination thereof as may be desired.

In embodiments where the display panel member is releasably or permanently secured to the lug engaging member the display panel member generally serves as an additional barrier (in addition to the lug) to prevent things hanging on the arm from sliding off the proximal end. The display panel member may also serve a safety function in that it presents a large flat shield on the proximal end of the arm so that any person or thing that falls against the proximal end of the arm is protected from encountering the relatively smaller proximal end of the arm.

According to embodiments where the display panel member includes an arm stop portion extending between the first and second leg elements, this arm stop portion generally defining a reverse face of the engagement cavity. The arm stop portion generally serves to prevent the proximal end from projecting through the engagement cavity. The reverse face may also serve to cooperate with the base portion in defining therebetween a lug engaging opening.

According to certain embodiments, the display panel member is releasably secured to the lug engaging member through a mechanical latching mechanism. In further embodiments the display panel member is permanently secured to the lug engaging member through an adhesive bond, weld, or the like, between the display panel and at least one of the opposed first and second leg portions.

In certain embodiments at least one of the opposed first and second leg portions includes an arm gripping portion. The arm gripping portion is positioned to grippingly engage the arm. The gripping force provided by this gripping portion aids in retaining the proximal end of the arm in the engagement cavity.

The arms in some free standing display stands extend generally horizontally. These are generally described as “straight” arms. In other display stand configurations the arms angle downwardly so the proximal end of the arm is below its distal end. Such arms are often described as “cascading” or “waterfall” arms. In angularly extending cascading arms the lug engaging member is adapted to engage the generally angularly extending proximal end.

According to certain embodiments, the lug engaging member and display panel members include between them a retaining element projecting outwardly from one of these members, and a slot element configured to releasably engage with the retaining element on the other of these members. In one configuration, the retainer element is on the lug engaging member, and in another embodiment the retainer element is on the display panel member. Certain embodiments include a retaining element projecting rotatably from one member and a slot element configured to releasably engage with the retaining element on the other member. In certain embodiments the lug engaging member includes opposed attachment panels projecting generally laterally from the legs and adapted to being permanently or releasably attached to generally planer locations on display panel members.

Certain embodiments of the lug mount system wherein the display panel member is releasably attached to the lug engaging member include a plurality of display panel members. Information can be applied to a plurality of display panel members at, for example, a central location remote from the free standing display stand. The display panel members may then be brought to a free standing display stand and attached to the proximate ends of the arms as desired. When, for example, a decision is made to change all or some of the goods on a particular arm, the display panel member on that arm may be quickly changed to reflect information about the new goods.

According to certain embodiments a mechanical locking mechanism is provided, which is adapted to secure a display panel member to a lug engaging member by way of a detent member latchingly engaged with a detent plate. Further, the detent member is mounted to the lug engaging member, and the detent plate is mounted to the display panel member.

The detailed description of the invention below is intended to merely be an example and is in no way intended to limit the scope of the invention to this example. Accordingly, modifications to the description below are possible, and it should be clearly understood that the invention may be practiced in many different ways than the example specifically described below, and still remain within the scope of the invention and the claims.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a front view diagrammatically depicting an embodiment of a lug mount system wherein a generally U-shaped lug engaging member is secured to a display panel member;

FIG. 2 depicts a side view of the embodiment of FIG. 1;

FIG. 3 depicts a bottom view of the embodiment of FIG. 1;

FIG. 4 depicts a diagrammatic broken side view of a prior art display stand arm;

FIG. 5 depicts a cross-sectional view taken along line 5-5 in FIG. 4;

FIG. 6 depicts a diagrammatic broken side view of the embodiment of FIG. 1 mounted to the prior art display stand arm of FIG. 4;

FIG. 7 depicts a cross-sectional view taken along line 7-7 in FIG. 6;

FIG. 8 depicts a diagrammatic side view of an embodiment in which the display panel member includes a hinged face or frame panel element that hingedly opens as indicated by a double headed arrow to provide a pocket for receiving a sheet of material bearing information (not shown);

FIG. 9 depicts a diagrammatic side view of an embodiment of a display panel member in which a face or frame element is bonded at a lower portion to flex open as indicated by a double headed arrow to provide a pocket for receiving a sheet of material bearing information (not shown);

FIG. 10 depicts a diagrammatic side view of an embodiment of a display panel member in which a face or frame element is unitary with a lower portion of a backing panel to flex open as indicated by a double headed arrow to provide a pocket for receiving a sheet of material bearing information (not shown);

FIG. 11 depicts a diagrammatic side view of an embodiment of a display panel member in which a face or frame element is unitary with a lower edge of a backing panel to flex open as indicated by a double headed arrow along a living hinge to provide a pocket for receiving a sheet of material bearing information (not shown);

FIG. 12 depicts diagrammatic a side view of an embodiment of a display panel member in which a face or frame element is separate from a backing panel to move away from the backing panel as indicated by a double headed arrow to provide a pocket for receiving a sheet of material bearing information (not shown);

FIG. 13 depicts a diagrammatic side view of an embodiment of a lug engaging member in which a headed retainer element projects therefrom;

FIG. 14 depicts a diagrammatic front view of an embodiment of a dispaly panel member in which a pair of slot elements is formed in a backing panel, which slot elements are especially configured to releasably engage with a headed retainer element;

FIG. 15 depicts diagrammatically in sequence from left to right the steps in the engagement of a headed retainer element with a specially configured slot element;

FIG. 16 depicts a diagrammatic perspective view of an embodiment of lug engaging member in which headed retainer elements project outwardly therefrom;

FIG. 17 depicts a diagrammatic side view of an embodiment of a lug engaging member of FIG. 13 releasably engaged with a generally Z-shaped display panel member;

FIG. 18 depicts a diagrammatic perspective view of an embodiment of a lug mount system wherein the engaging member includes a leg portion with an arm gripping portion that is free to flex as indicated by a double headed arrow;

FIG. 19 depicts a diagrammatic perspective view of a conventional free standing display stand with straight arms;

FIG. 20 depicts a diagrammatic front view of an embodiment of a display panel member in which a pair of slot elements are formed in a backing panel, which slot elements are especially configured to releasably engage and mechanically interlock with a headed retainer element so that compound movement is required to release the display panel member from the lug engaging member;

FIG. 21 depicts diagrammatically the steps in interengaging a rotatably mounted retaining element and a specially configured slot element in a display panel; and

FIG. 22 depicts diagrammatically the steps in interengaging additional embodiments of a rotatably mounted retaining element and a specially configured slot element in a display panel.

FIG. 23 depicts a diagrammatic side view of an embodiment of a lug engaging member in which a detent member projects laterally therefrom;

FIG. 24 depicts a front view diagrammatically depicting an embodiment of a lug mount system wherein a detent plate is secured to a display panel member;

FIG. 25 depicts a diagrammatic side view of the embodiment of FIG. 24;

FIG. 26 depicts a diagrammatic side view of the embodiments of FIGS. 23 and 24 engaged with one another in a mechanical locking configuration;

FIG. 27 depicts a diagrammatic end view of the embodiment of FIG. 23;

FIG. 28 depicts a diagrammatic top view of the embodiment of FIG. 23;

FIG. 29 depicts a diagrammatic top view of an additional embodiment wherein an end of an arm in a display stand (not shown) is affirmatively retained in the engagement cavity that is defined by this embodiment of a lug engaging member;

FIG. 30 depicts a diagrammatic bottom view of the embodiment of FIG. 29; and

FIG. 31 depicts a diagrammatic cross-sectional view of a display stand arm engaged in the embodiment of FIG. 29.

### DETAILED DESCRIPTION OF THE PREFERRED EMBODIMENTS

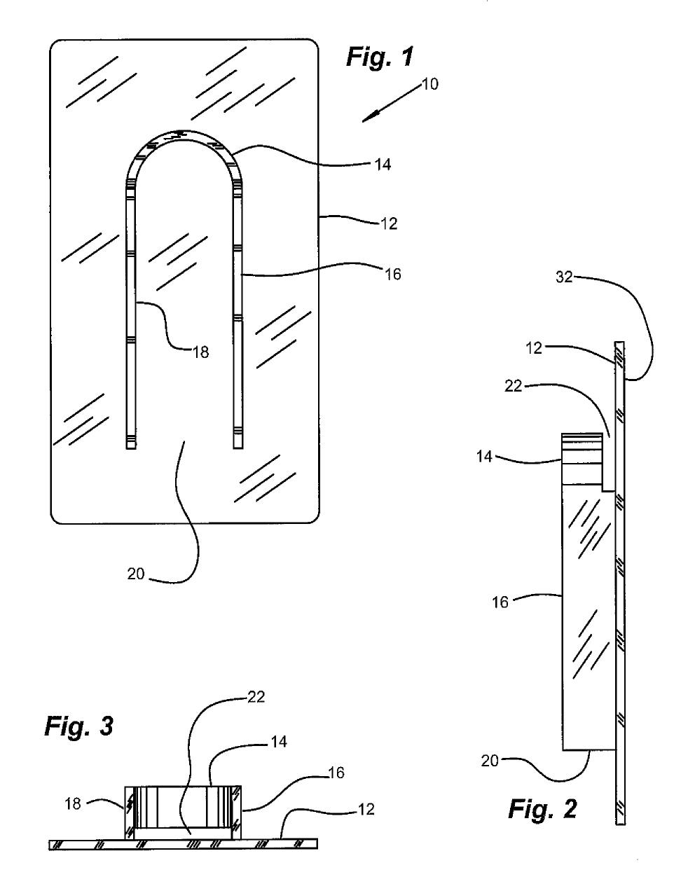

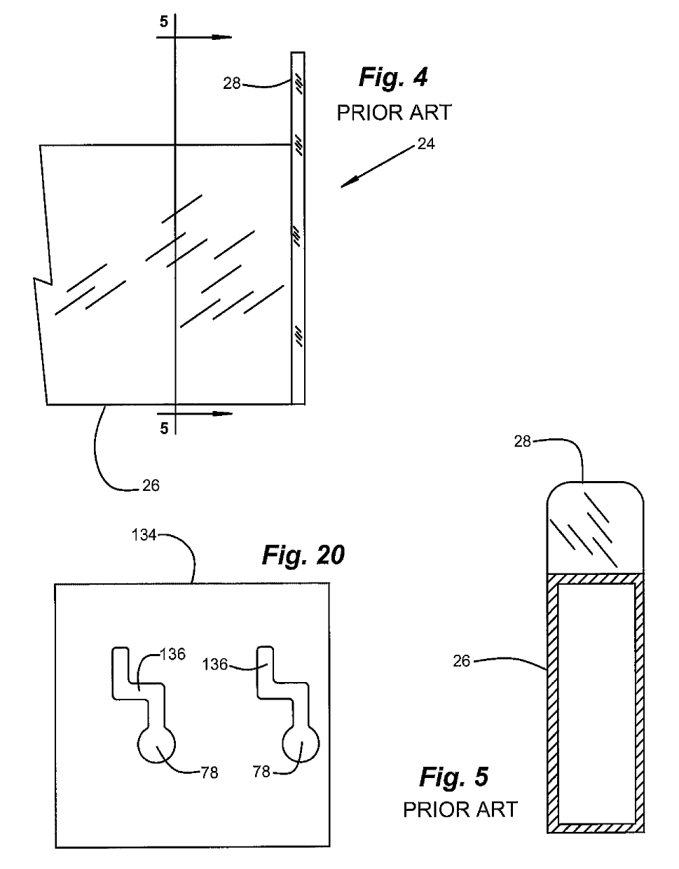

In the embodiment chosen for illustration in FIGS. 1, 2, and 3, depict a lug-mount system indicated generally at 10 for mounting on the end of conventional free standing display stand arms 26 (FIGS. 4 and 5) to provide for displaying graphical or textual information on a display face 32 of a display panel member 12. A lug engaging member has a generally U-shaped configuration composed of base portion 14 extending between first leg portion 16 and second leg portion 18. The leg portions are opposed to one another. Opposed to base portion 14 is an open side 20. A portion of base portion 14 adjacent to display panel member 12 is removed to form a lug engaging opening 22 between base portion 14 and the adjacent face of display panel 12. The embodiment depicted in FIGS. 1, 2, and 3 is illustrative of those embodiments in which at least one of the first or second leg portions is permanently secured by an edge to the adjacent surface of display panel member 12.

FIGS. 4 and 5 depict generally at 24 the proximal end of an arm 26 of a conventional free standing display stand 126 (FIG. 19). A lug 28 projects normally upwardly from and terminates arm 26. Lug 28 is generally planar and extends generally normal to the major axis of arm 26.

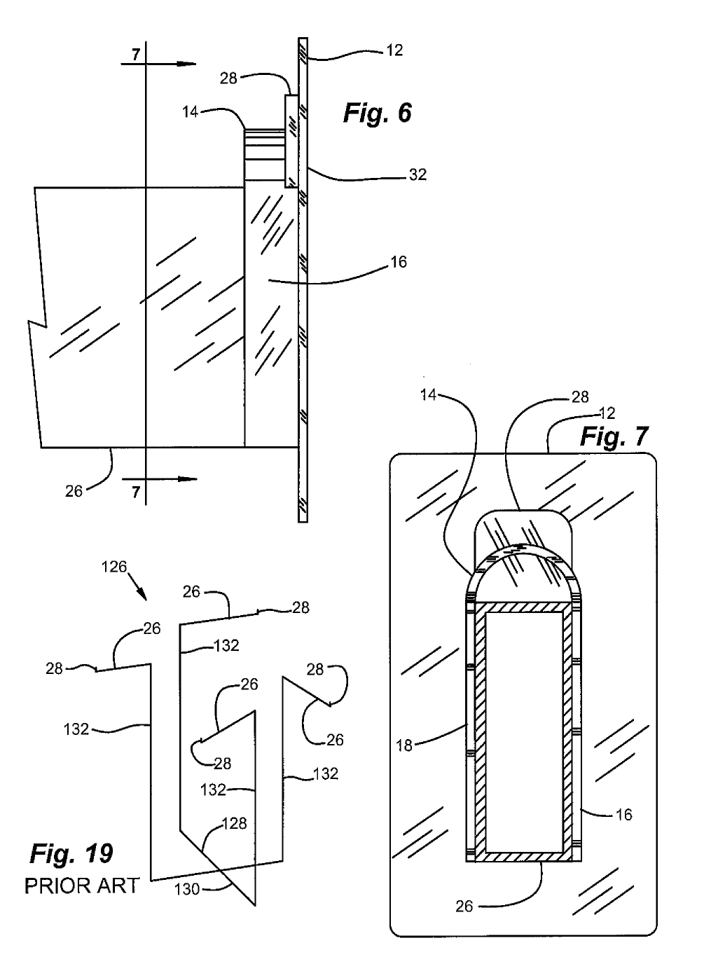

FIGS. 6 and 7 depict generally the assembly of arm 26 together with lug mount system 10 (FIG. 1). As illustrated in these Figs., the arm 26 fits snugly into an engagement cavity that is formed by the generally U-shaped lug engaging member in cooperation with display panel member 12.

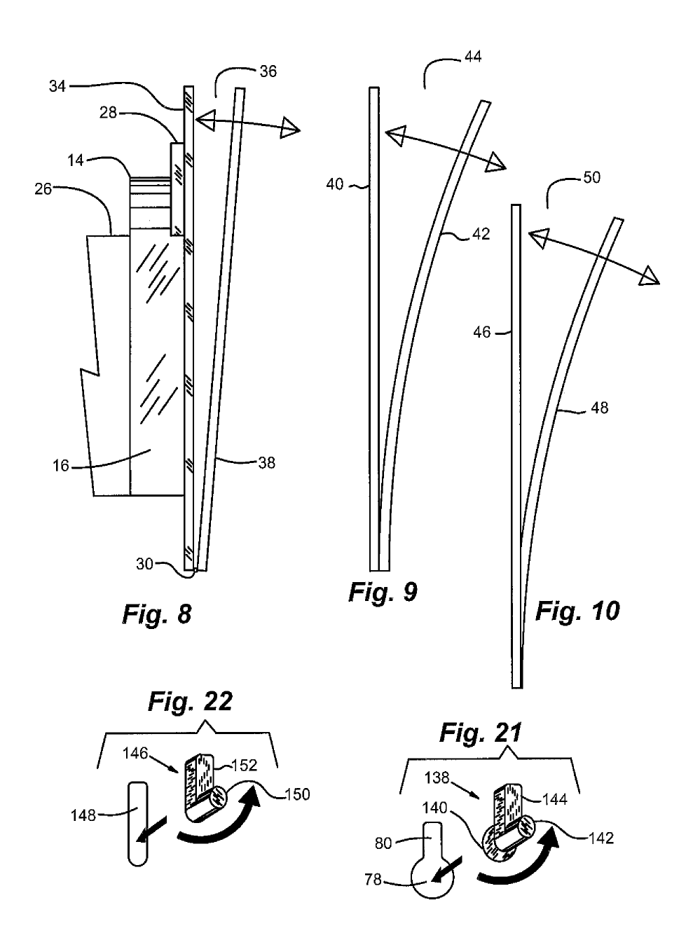

FIG. 8 depicts an embodiment of a lug-mount system mounted on an arm in which a lug engaging member is secured to a display panel that is hinged at 30 to permit transparent panel 38 to swing as indicated by the double headed arrow to provide a pocket 36 to receive a sheet of material upon which information is provided.

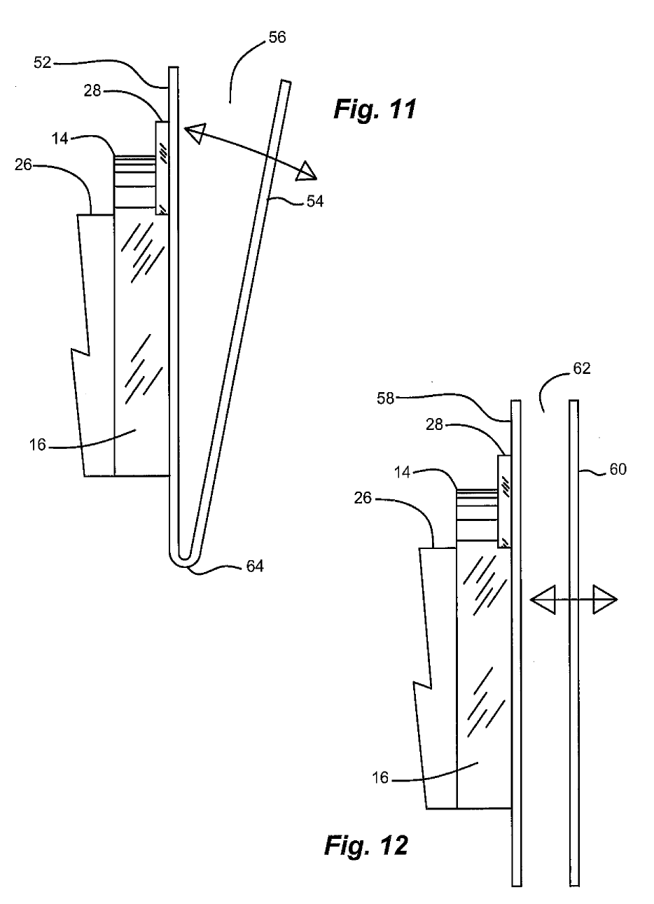

FIGS. 9 through 12 depict embodiments of various display panel member embodiments. In the embodiment of FIG. 9, front panel 42 is affixed to and flexibly deflectable away from back panel 40 to provide pocket 44. In the embodiment of FIG. 10, panels 46 and 48 are formed from the same sheet of material, and are cut so that portion 48 is deflectable away from panel 46 to provide pocket 50. In the embodiment of FIG. 11, panels 52 and 54 are connected through a living hinge 64 that is sufficiently flexible to allow the panels to separate to form pocket 56. In the embodiment of FIG. 12, panels 58 and 60 are separate from one another to form pocket 62, and are secured together in use by means of one or more separate clips (not shown).

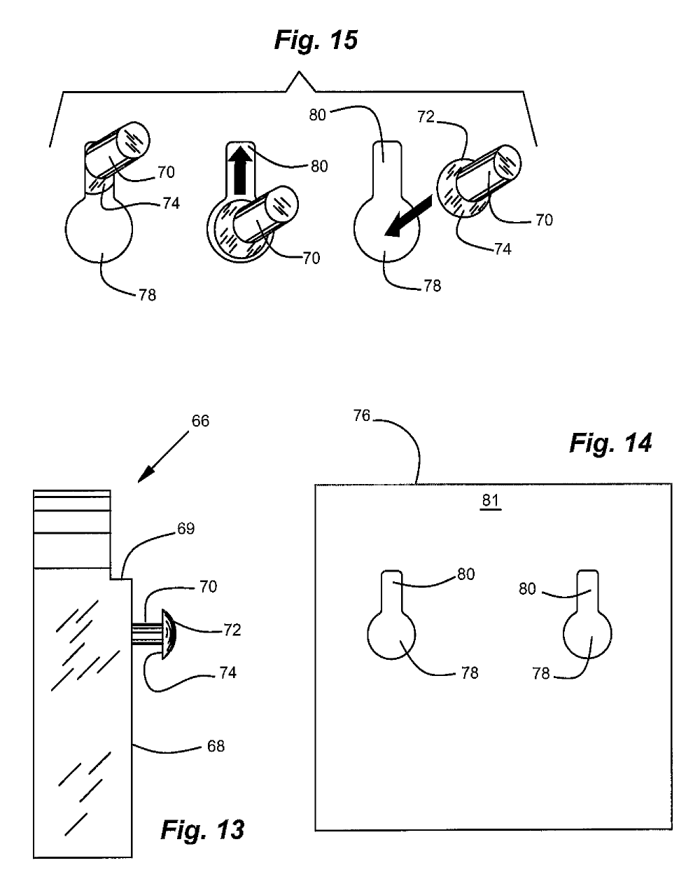

FIGS. 13 and 14 depict embodiments of a lug-mount system wherein a lug engaging member indicated generally at 66 mechanically and releasably interlocks with display panel member 76 to secure the two together. In the illustrated embodiment, a retaining element comprised of an enlarged head 72 with a shoulder 74 is mounted on a shank 70. Shank 70 is attached to first leg portion 68 of lug engaging member 66. A similar retaining element is attached to opposed second leg portion (not shown). Enlarged head 72 is sized to fit through circular portion 78 of a keyhole slot in display panel 76 but not straight channel 80. Shank 70 is sized so that it fits through straight channel 80 as depicted, for example, in FIG. 15. Shoulder 74 engages display panel 78 on a side of such display panel member that is opposed to lug engaging member 66. Lug engaging member 66 and display panel 76 are thus releasably secured together. A boss 69 is formed in lug engaging member 66 so that a portion of the lug engaging member 66 is spaced from region 81 of display panel member 76 when the retaining element is received in the slot element that is defined by circular portion 78 and straight channel 80 in display panel member 76. A similar boss is shown in the opposed leg portion (not shown).

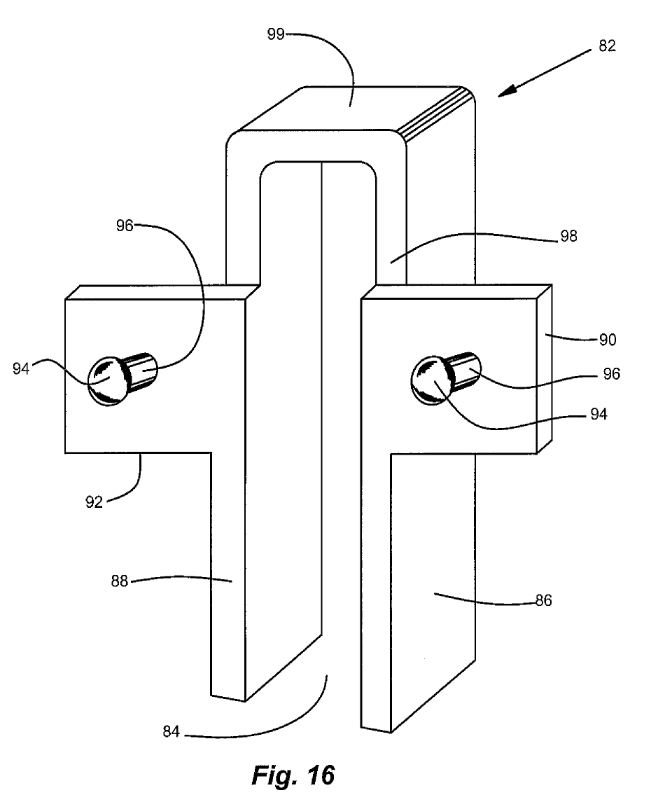

FIG. 16 depicts an embodiment of a generally U-shaped lug engaging member indicated generally at 82. An attachment panel 90 is unitary with and projects generally laterally from first leg portion 86. Similarly attachment panel 92 projects generally laterally from second leg portion 88. A step 98 in first leg portion 86 together with a similar step in second leg portion 88, which steps are continued through base portion 99, serve to space the base portion from the adjacent surface of a display panel that is mounted to lug engaging member 82. Enlarged heads 94 and shanks 96 serve to releasably engage a display panel as previously described.

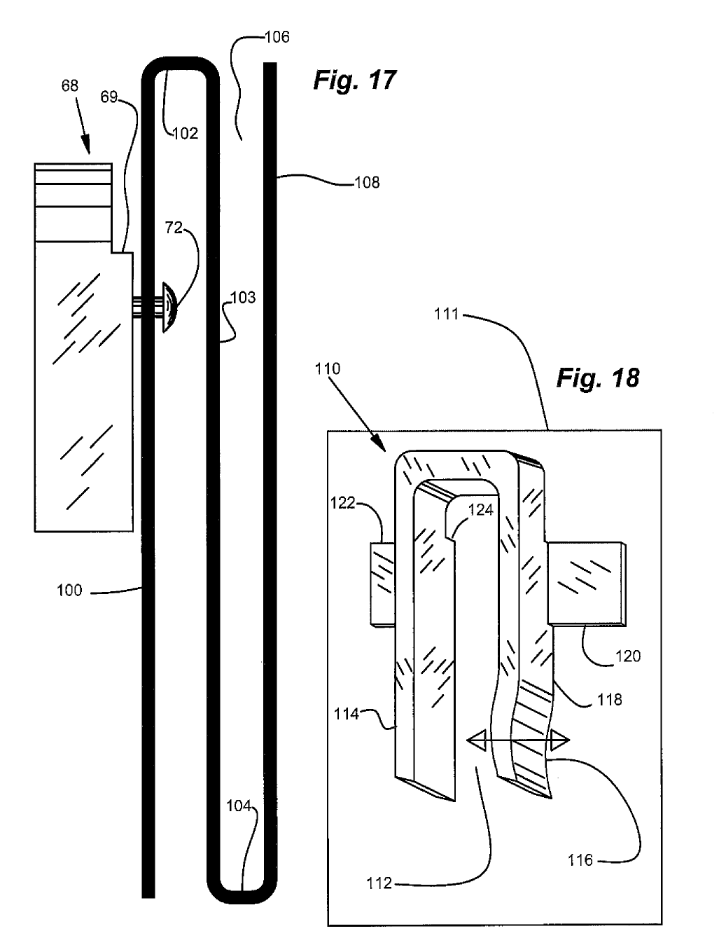

FIG. 17 depicts an embodiment wherein lug engaging member 66 (FIGS. 13 and 15) is interengaged with a generally Z-shaped display panel member. Back panel 100 is provided with slot elements as depicted, for example, in FIG. 14 or 20. Bend 102 serves to space back panel 100 from panel 103 sufficiently so that enlarged head 72 fits between the two panels. Bend 104 serves to space panels 103 and 108 far enough apart to receive in pocket 106 information or an information display device such as, for example, an LCD screen (not shown) or other electronic displays.

FIG. 18 depicts an embodiment of a lug engaging member indicated generally at 110 with opposed attachment panels 120 and 122, a boss 124, an open side 112, a first leg portion 114, and a second leg portion 118. Second leg portion 118 includes a leg gripping portion 116 that is free to flex as indicated by the double headed arrow. The purpose of gripping portion 116 is to firmly clamp the proximal end of an arm that is inserted into the engagement cavity defined by display panel member 111 and U-shaped lug engaging member 110.

FIG. 19 depicts a conventional free standing display stand indicated generally at 126. Arms 26 terminate in lugs 28, and project generally laterally of generally vertically extending rails 132. Rails 132 are mounted in normally horizontally extending feet 128 and 130.

FIG. 20 depicts an embodiment of a display panel member 134 in which slot elements are configured so that compound motion is required to move the display panel to a position where it may be disengaged from the lug engaging member. Each of the slot elements includes a circular portion 78 that is adapted to receive an enlarged head of a retaining element. Channels 136 are configured so that the shanks of engaging elements must be moved downwardly, laterally, and downwardly again before the display panel member and the lug engaging member may be released from one another.

FIGS. 21 and 22 depict embodiments of retaining elements that are adapted to project through a slot element and rotatably engage therewith. A retaining element indicated generally at 138 includes an enlarged head 140 that is adapted to pass through circular portion 78. It also includes a fin 144 that projects outwardly from rotatable shaft 142. Fin 144 is adapted to pass through channel 80 when aligned therewith. As soon as shaft 142 is rotated to bring fin 144 out of alignment with channel 80, the two members in which the slot element and the rotatable engagement element are located are releasably secured together. In the embodiment depicted in FIG. 22, a rotatable retainer element indicated generally at 146 performs similarly to retainer element 138 except that there is no head and the releasable engagement function is performed by fin 152 and channel 148.

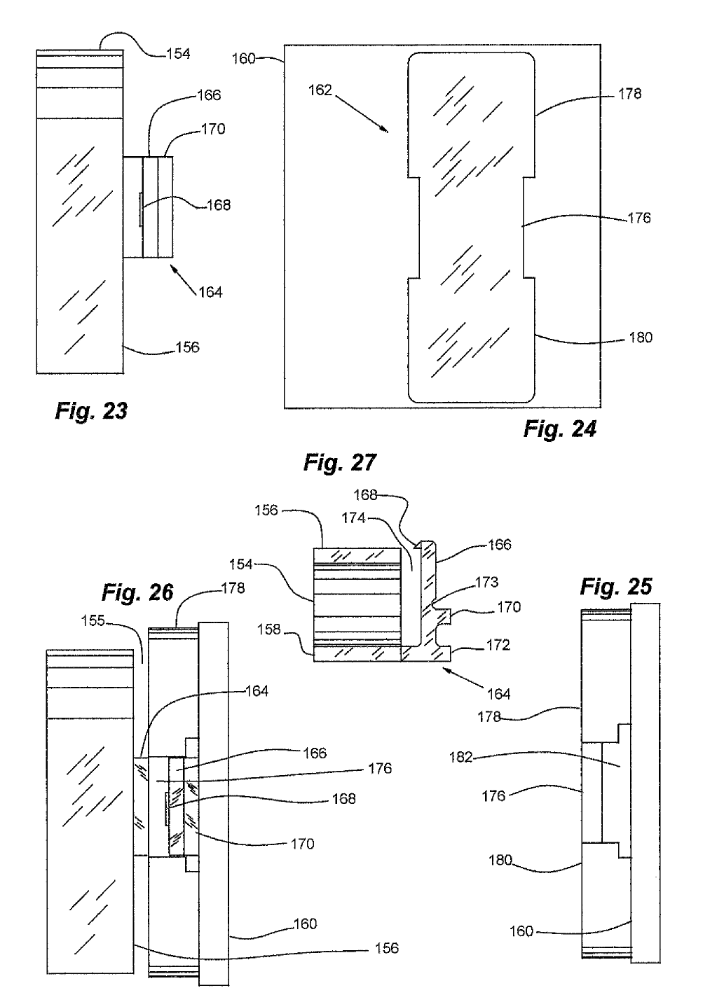

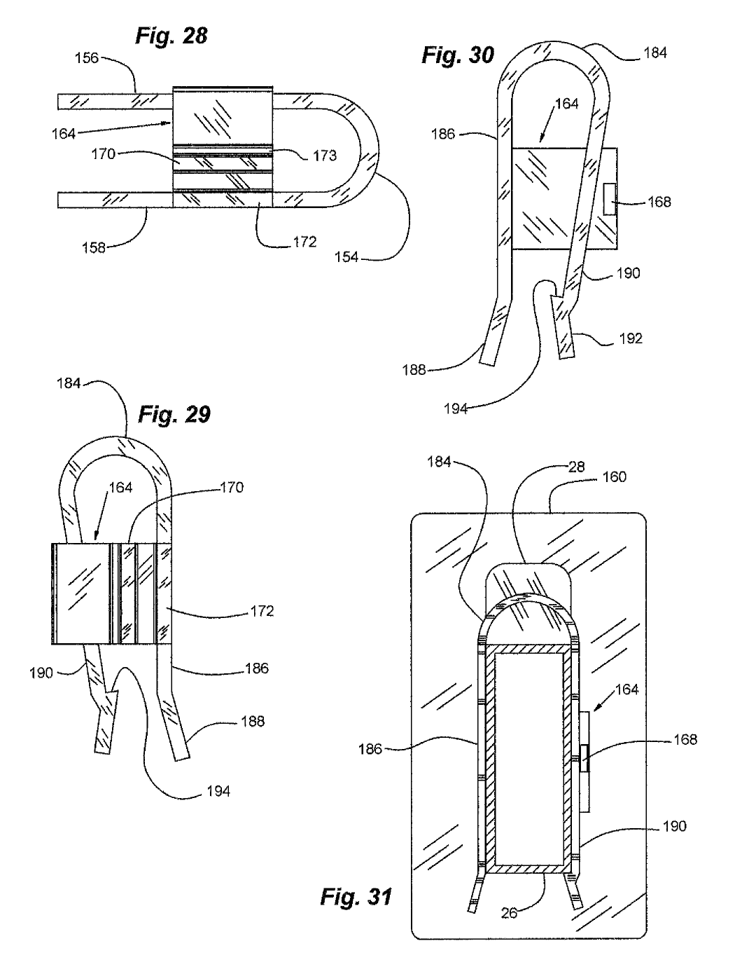

FIGS. 23, 27, and 28 depict an embodiment of a lug mount system comprised of a generally U shaped lug engaging member including base portion 154 from which first and second leg portions 156 and 158, respectively depend. A detent member 164 projects laterally from and is integral with this embodiment. A detent plate 162 is adapted to being adhered to a surface of display panel 160. Together, detent plate 162 and detent member 164 serve as retainer elements that retain display panel 160 and a lug engaging member in operative assembly with one another.

Detent member 164 generally has an “L” shape and is comprised of a flex groove 173 that extends laterally for the full width of detent tongue 166. Fulcrum bar 170 and spacer 172 are adapted to bear against an adjacent surface of a display panel. A purpose of flex groove 173, in leveraging cooperation with fulcrum bar 170, is to permit the free end of detent tongue 166 to deflect far enough to permit latch element 168 to engage and disengage with latch plate 176 (FIGS. 24, 25, and 26). Spacer 172, in cooperation with fulcrum bar 170, serves to stabilize detent member 164 relative to an adjacent surface of a display panel, such as display panel 160 that extends between the leg portions 156 and 158 (see, for example, FIG. 26).

In the embodiment chosen for purposes of illustration, latch plate 176 is the element in detent plate 162 that bridges across passageway 182 (FIG. 25) between first pier 178 and second pier 180. Piers 178 and 180, respectively, are adapted to being adhered to the surface of a display panel, such as display panel 160. According to certain embodiments, Piers 178 and 180, respectively, are permanently and rigidly adhered to the surface of display panel 160.

Channel 174, which is between detent tongue 166 and the adjacent edge of the associated leg engaging member, is adapted to receiving the full width of latch plate 176 therewithin when detent tongue 166 is fully inserted through passageway 182. Lug engaging opening 155 (FIG. 26) is adapted to receive lug 28. Lug engaging opening 155 is formed when detent tongue 166 is inserted into passageway 182. Detent member 164 is generally “L” shaped when viewed in an end view (FIG. 27). The short leg of the L is of such a length that the leg engaging member is spaced from detent tongue 166 for a distance that is about equal to the thickness of latch plate 176 plus the width of lug engaging opening 155. The thickness of passageway 182 between the passageway side of latch plate 176 and the surface of display panel 160 is about equal to the distance between the channel side of detent tongue 166 and the terminus of fulcrum bar 170. Fulcrum bar 170 is adapted to engage the surface of display panel 160. When detent tongue 166 is fully inserted through passageway 182, latch element 168 latchingly engages the edge of latch plate 176 to prevent detent tongue 166 from being withdrawn from passageway 182. Fulcrum bar 170 and spacer 172 bear against the adjacent surface of display panel 160 to prevent detent member 164 from being accidentally rotated to a disengaged configuration. The opposed sides of passageway 182 closely confine the respective mating passageway edges of detent tongue 166, so rotation of detent member 164 relative to detent plate 162 in the plane of detent tongue 166 is generally prevented. It is generally necessary to simultaneously bend detent tongue 166 at flex groove 173 towards the surface of display panel 160 and withdraw detent tongue 166 from passageway 182 to effect disengagement of detent member 164 from detent plate 162.

The embodiment chosen for illustration purposes in FIGS. 29, 30, and 31 is illustrative of certain of those embodiments that are adapted to positively engage and retain a lug bearing display stand arm 26 in a lug engaging member. First leg portion 186 and second leg portion 190 are formed so that they converge towards one another in an unconstrained configuration. Base portion 184 is sufficiently flexible to permit the respective leg portions 186 and 190 to flex away from one another into a generally parallel configuration responsive to the insertion of the end of a lug bearing display stand arm 26 therebetween (FIG. 31). Detent member 164 functions to lockingly engage with a mating detent plate 162, as previously described. Ramp leg 188 and retainer leg 192 are angled divergently away from one another to generally form a “V” shaped opening that is adapted to receive the end of a lug bearing display stand arm 26, and allow it to wedge leg portions 186 and 190, respectively, apart. When fully inserted lug 28 projects through channel 155 (FIG. 26) and an edge of the normally lower side of lug bearing display stand arm 26 is engaged by retainer boss 194 (FIG. 31). The engagement with retainer boss 194 serves to prevent lug bearing display stand arm 26 from being accidently dislodged from a fully engaged configuration with the lug engaging member. Because of the spring bias of the respective leg portions 186 and 190 towards one another, this structure provides a spring biased retention of lug bearing display stand arm 26. Disengagement is effected by moving retainer leg 192 outwardly until retainer boss 194 disengages from lug bearing display stand arm 26.

The retainer elements of the various embodiments may be mounted to the display panel members, the lug engaging members, or they may be separate pieces that extend through both members to secure them together.

The foregoing detailed description of the invention is intended to be illustrative and not intended to limit the scope of the invention. Changes and modifications are possible with respect to the foregoing description, and it is understood that the invention may be practiced otherwise than that specifically described herein and still be within the scope of the claims.

What is claimed is:

1. A lug-mount system for presenting information on an end of an arm in a display stand, said end including a lug element projecting generally upwardly from said arm at approximately a proximal end of said arm, said lug-mount system comprising:
a lug engaging member, said lug engaging member having a generally U-shaped configuration and including a base portion extending between opposed first and second leg portions, said portions defining therebetween three sides of an engagement cavity, said engagement cavity being adapted to receive said end therewithin, a lug engaging opening generally extending through said base portion and adapted to releasably interengage with said lug element; and
a display panel member adapted to present said information, said display panel member secured to said lug engaging member, said display panel member including a reverse face portion extending between said first and second leg elements.

2. A lug mount system of claim 1 wherein said display panel member is releasably secured to said lug engaging member.

3. A lug mount system of claim 1 wherein said display panel member is permanently secured to said lug engaging member.

4. A lug mount system of claim 1 wherein said display panel member is releasably secured to said lug engaging member through a mechanical locking mechanism.

5. A lug mount system of claim 1 wherein said display panel member is releasably secured to said lug engaging member through a mechanical locking mechanism comprising a detent plate secured to said display panel member and a detent member secured to said lug engaging member.

6. A lug mount system of claim 1 wherein said display panel member is permanently secured to said lug engaging member through a bond between said display panel member and at least one of said opposed first and second leg portions.

7. A lug mount system of claim 1 wherein at least one of said opposed first and second leg portions includes an arm gripping portion.

8. A lug mount system of claim 1 wherein said arm is a cascading arm and said end extends generally angularly downwardly, and lug engaging member is adapted to engage said generally angularly downwardly extending end.

9. A lug mount system of claim 1 wherein said lug engaging member includes a retaining element projecting therefrom and said display panel member includes a slot element configured to releasably engage with said retaining element.

10. A lug mount system of claim 1 wherein said lug engaging member includes a retaining element projecting rotatably therefrom and said display panel member includes a slot element configured to releasably engage with said retaining element.

11. A lug mount system of claim 1 wherein said display panel member includes a pocket adapted to open and retainingly receive a sheet of material bearing said information.

12. A lug-mount system for presenting information on an end of an arm in a display stand, said end including a lug element projecting generally upwardly from said arm at approximately a proximal end of said arm, said lug-mount system comprising:
a lug engaging member, said lug engaging member having a generally U-shaped configuration and including a base portion extending between opposed first and second leg portions, said portions defining therebetween three sides of an engagement cavity, said engagement cavity being adapted to receive said end therewithin, a lug engaging opening generally extending through said base portion and adapted to releasably interengage with said lug element; and
a display panel member adapted to present said information, said display panel member secured to said lug engaging member, said display panel member including a reverse face portion extending between said first and second leg elements, said display panel member being releasably secured to said lug engaging member through a mechanical locking mechanism comprising a detent plate and a detent member.

13. A lug mount system of claim 12 wherein said detent plate is mounted to said display member, and said detent member is mounted to said lug engaging member.

14. A lug-mount system for presenting information on an end of an arm in a display stand, said end including a lug element projecting generally upwardly from said arm at approximately a proximal end of said arm, said lug-mount system comprising:
a lug engaging member, said lug engaging member having a generally U-shaped configuration and including a base portion extending between opposed first and second leg portions, said portions defining therebetween three sides of an engagement cavity, said engagement cavity being adapted to receive and resiliently engage said end therewithin, a lug engaging opening generally extending through said base portion and adapted to releasably interengage with said lug element, said second leg portion including a retainer boss adapted to engage an edge of a normally lower side of said arm; and
a display panel member adapted to present said information, said display panel member secured to said lug engaging member, said display panel member including a reverse face portion extending between said first and second leg elements, said display panel member being releasably secured to said lug engaging member through a mechanical locking mechanism comprising a detent plate and a detent member.

15. A lug mount system of claim 14 wherein said detent plate is mounted to said display member, and said detent member is mounted to said lug engaging member.
